(19) United States
(12) Patent Application Publication
(10) Pub. No.: US 2025/0027409 A1
(43) Pub. Date: Jan. 23, 2025

(54) AUTOMATED METHOD AND SYSTEM TO DETECT SEGMENT ROCK PARTICLES

(71) Applicant: Schlumberger Technology Corporation, Sugar Land, TX (US)

(72) Inventors: Josselin Kherroubi, Paris (FR); Matthias Francois, Clamart (FR); Tetsushi Yamada, Cambridge, MA (US)

(21) Appl. No.: 18/779,680

(22) Filed: Jul. 22, 2024

Related U.S. Application Data
(60) Provisional application No. 63/514,671, filed on Jul. 20, 2023.

(51) Int. Cl. E21B 49/00; G06F 3/04817; G06V 10/77; G06V 10/82; G06V 20/10; G06V 20/70

(52) U.S. Cl. CPC E21B 49/005; G06F 3/04817; G06V 10/7715; G06V 10/82; G06V 20/10; G06V 20/70

(57) ABSTRACT

Systems and methods are provided for analyzing sample images, such as for rock particles obtained during drilling of a geologic formation. The system and techniques utilize a Large Foundation Model (LFM) in the segmentation of rock particles. The LFM can receive an image (or image data) of rock particles as an input and generates segmentation of the image at a pixel level (i.e., each pixel of the image is classified) as a segmented image. Additionally, active annotation can be provided in conjunction with a graphics user interface (GUI) to allows for user interaction with images as well as selective segmentation of the images.

### CROSS REFERENCE TO RELATED APPLICATION

This application claims priority to and the benefit of U.S. Provisional Application No. 63/514,671, filed on Jul. 20, 2023, the entirety of which is incorporated herein by reference.

### BACKGROUND

The present disclosure relates generally to a method and system for analyzing sample images, such as for rock particles obtained during drilling of a geologic formation. In particular, the present disclosure relates to utilizing automated image processing to detect rock particle instances in sample images.

During the drilling process of an oil well or of a well of another effluent—in particular gas, vapor or water—rock particles are brought to the surface after they have been cut from the geologic formation by a drilling bit and brought to surface by a mud circulating in the wellbore. An analysis may be performed on the rock particles to enable the creation of a detailed record (e.g., a master log) of the geologic formations of a wellbore. The detailed record may be a function of the wellbore depth and may enable a determination of various wellbore information, for example, the lithology of the geologic formation.

Generally, the sample images are analyzed by a geologist to determine the nature of the rock particles, so as to determine the lithology of the geologic formation from which the rock particles are extracted. However, such work takes a substantial amount of time and is generally performed in a lab away from the drilling installation, which makes it less efficient to control the drilling process based on the results of the analysis. Further, such work is highly subjective as it is based on human observation. Therefore, it is desirable to have an improved method to analyze the sample images.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Certain embodiments of the present disclosure include a system comprising one or more processors and memory, accessible by the one or more processors, and storing instructions that, when executed by the one or more processors, cause the one or more processors to perform operations comprising receiving image data of an image of rock samples from an imaging system, analyzing the image data via an Artificial Intelligence (AI) model trained using a plurality of images, and generating a segmented image based on the analyzing of the image data by the AI model, wherein the segmented image comprises characterizations of the rock samples of the image data.

Certain embodiments of the present disclosure include a computer-implemented method, comprising receiving image data of an image of rock samples from an imaging system, analyzing the image data via an Artificial Intelligence (AI) model trained using a plurality of images, and generating a segmented image based on the analyzing of the image data by the AI model, wherein the segmented image comprises characterizations of the rock samples of the image data.

Certain embodiments of the present disclosure include a device, comprising a display, a processor communicatively coupled to the display, and a memory communicatively coupled to the processor, the memory storing instructions which, when executed, cause the processor to perform operations comprising generating a graphical user interface (GUI), generating an image of rock samples corresponding to image data received from an imaging system for presentation on the display, receiving a first input via a first user interaction with the GUI, generating a visual icon for display on the display at a particular location on the image of rock samples displayed on the display, wherein the particular location is determined based upon the first input, receiving a second input via a second user interaction with the GUI, and in response to the second input, analyzing at least a portion of the image data via an Artificial Intelligence (AI) model trained using a plurality of images and generating a segmented image based on the analyzing of the at least a portion of the image data by the AI model, wherein the segmented image comprises characterizations of the at least a portion of the rock samples.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic diagram of a drilling installation comprising a geological analysis system, in accordance with aspects of the present disclosure;

FIG. 2 is a flowchart of a method for generating a detailed record for the system of FIG. 1, in accordance with aspects of the present disclosure;

FIG. 3 is an example of a first image to be analyzed by the analysis system of FIG. 1, in accordance with aspects of the present disclosure;

FIG. 4 an example of a first segmented image generated based on the first image of FIG. 3, in accordance with aspects of the present disclosure;

FIG. 5 an example of a second segmented image generated based on the first image of FIG. 3, in accordance with aspects of the present disclosure;

FIG. 6 is an example of a second image to be analyzed by the analysis system of FIG. 1, in accordance with aspects of the present disclosure;

FIG. 7 is an example of a graphical user interface (GUI) interacting with the second image of FIG. 6, in accordance with aspects of the present disclosure;

FIG. 8 is an example of a first segmented image generated based upon the second image of FIG. 6, in accordance with aspects of the present disclosure;

FIG. 9 is an example of the GUI interacting with the first segmented image of FIG. 8, in accordance with aspects of the present disclosure; and

FIG. 10 is an example of a second segmented image generated based upon the first segmented image of FIG. 8, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.”

In addition, as used herein, the terms “real-time”, “real-time”, or “substantially real-time” may be used interchangeably and are intended to described operations (e.g., computing operations) that are performed without any human-perceivable interruption between operations. For example, data relating to the systems described herein may be collected, transmitted, and/or used in control computations in “substantially real-time”, such that data readings, data transfers, and/or data processing steps may occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, solely by analysis system without human intervention.

The present disclosure relates to a system and method for analyzing images of cutting samples taken by a drilling system from a geologic formation. The cutting samples have been cut from the geologic formation during drilling and may be used to evaluate the geologic formation and characterize one or several of its properties, such as its mineralogy, lithology, porosity, density, etc., based on a position (e.g., X, Y, Z coordinates and/or depth) in the geologic formation. For example, the images of the cutting samples may be used to identify lithology of the rocks in the cutting samples and predict characteristics and parameters for the geologic formation. The lithology of the rock samples may be used to generate a detailed record (e.g., a master log file) for the geologic formation. The detailed record may include information regarding the geologic properties (e.g., lithology, layer, depositional environments) and petrophysical characterization (e.g., water saturation, porosity, permeability, volume of shale) of the geologic formation, which may be used to control the drilling system or a drilling plan of the drilling system. However, as an initial step to use of the cutting images to evaluate the geologic formation and characterize one or several of its properties, the images should be segmented (i.e., binary classification of the image at the pixel level).

In one embodiment, recognition of rock particles during the drilling of wells can be performed by an operator, for example, with the use of a microscope or another tool. This can be a time intensive process and results are often dependent on the operator (e.g., their experience level, etc.). Accordingly, in another embodiment, recognition of rock particles may be automated, for example, to reduce the cost of operation, to allow an operator to focus on tasks requiring more expertise.

One technique to automate the recognition of rock particles includes the use of machine learning or deep learning. In this embodiment, deep-learning or neural-network processor(s) or computing systems, including software-implemented neural networks, machine learning systems, or deep learning systems are trained and one or more models are generated that are then utilized to identify rock particles. The construction of this type of model can be a complex and/or lengthy process and can include extensive annotation of rock particles by a domain expert (with consistency check, etc.), design of the model, and its subsequent testing. Furthermore, the trained model(s) may have difficulty in being generally applicable. That is, it can be difficult to generate model(s) that are generalized for many types of formations (e.g., diverse geology) and/or that are robust to environmental variations (e.g., illumination, wet rock particles, etc.).

Accordingly, according to another embodiment, an alternative system and technique can be utilized whereby a Large Foundation Model (LFM) is utilized in the recognition of rock particles. Such a LFM can generally be considered to be an Artificial Intelligence (AI) model trained, in accordance with the present embodiment, on images. That is, present embodiments include an LFM that receives an image of rock particles as an input and generates classification of the image at a pixel level (i.e., each pixel of the image is classified). This allows for identification of, for example, an object and/or a shape of an object. One advantage of this embodiment is that it can operate without any rock particle specific training (e.g., zero shot learning). However, in some embodiments, retraining of the model can be undertaken using, for example, specific images of known rock particles. Additionally, in some embodiments, active annotation can be provided as part of a graphics user interface (GUI) to allow for user interaction with the classified images.

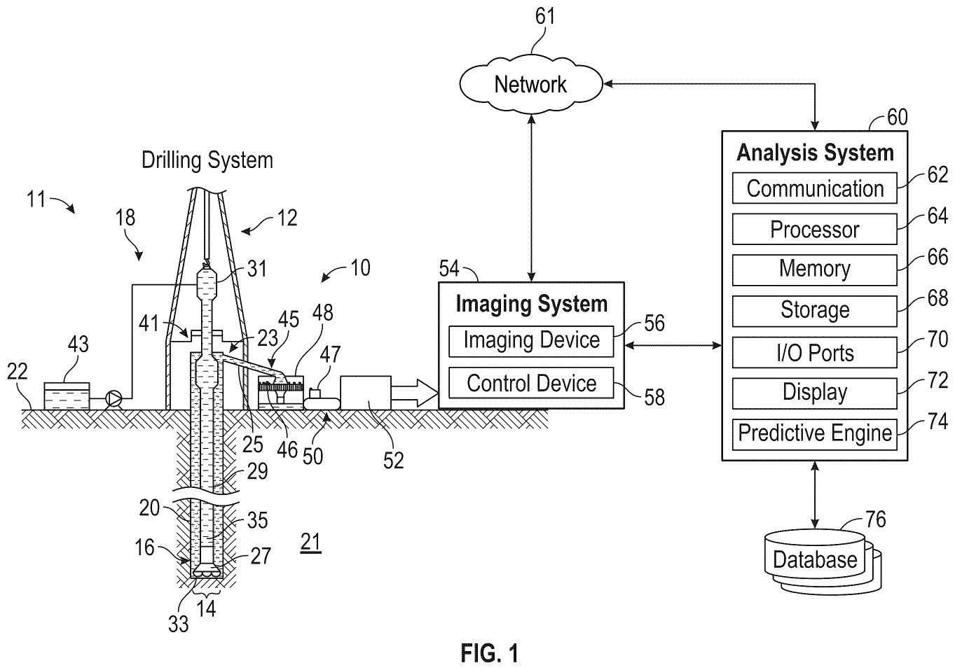

With forgoing in mind, FIG. 1 illustrates an example oil and gas worksite 10 with a geological analysis system 11 used for analysis and control with a drilling system 12. While the oil and gas worksite 10 is described, it should be appreciated that techniques described herein may be applied to other types of oil and gas production operations. The drilling system 12 includes a rotary drilling tool 14 used, for example, in drilling a cavity 16 as well as a surface installation 18 used, for example, in the placement of drilling pipes into the cavity 16. A wellbore 20 (e.g., wellbore), delimiting the cavity 16, is formed in the substratum 21 by the rotary drilling tool 14. At the surface 22, a well head 23 having a discharge pipe 25 closes the wellbore 20. The drilling tool 14 includes a drilling head 27, a drill string 29 and a liquid injection head 31. The drilling head 27 includes a drill bit 33 for drilling through the rocks of the substratum 21. The drilling head 27 is mounted on the lower portion of the drill string 29 and is positioned in the bottom of the wellbore 20. The drill string 29 includes a set of hollow drilling pipes. These pipes delimit an internal space 35, which makes it possible to bring a drilling fluid from the surface 22 to the drilling head 27. The liquid injection head 31 is mounted (e.g., threaded, bolted, etc.) onto the upper portion of the drill string 29. The drilling fluid includes a drilling mud, such as a water-based or oil-based drilling mud.

The surface installation 18 includes a support 41 for supporting the drilling tool 14 and driving it in rotation, an injector 43 for injecting the drilling fluid and a shale shaker 45. The injector 43 is hydraulically connected to the injection head 31 to introduce and circulate the drilling fluid in the internal space 35 of the drill string 29. The shale shaker 45 collects the drilling fluid flowing out from the discharge pipe 25. The drilling fluid is charged with drilling residues, known as rock particles (or cavings or cuttings). The shale shaker 45 includes a sieve 46 allowing the separation of the solid drilling rock particles, such as rock samples 47, from the drilling mud. The shale shaker 45 also includes an outlet 48 for evacuating the rock samples 47. The rock samples 47 obtained at the outlet 48 have been cut from the geologic formation during drilling and may be used to evaluate the geologic formation and characterize one or several of its properties, such as its mineralogy, lithology, porosity, density, etc.

In the embodiment shown in FIG. 1, the rock samples 47 may be automatically or manually sampled and transferred to a conveyor 50, which may transfer the rock samples 47 to a preparation device 52. The preparation device 52 may prepare the rock samples 47 before sending them to an imaging system 54 manually or automatically (e.g., via a conveyance device). The geological analysis system 11 may include all equipment associated with acquiring, preparing, imaging, and analyzing the rock samples 47. For example, the geological analysis system 11 may include the shale shaker 45, the conveyor 50, the preparation device 52, the imaging system 54, and an analysis system 60. The preparation may include washing, rinsing, drying, or sieving the sample of rocks, etc. The imaging system 54 may include an imaging device 56 to take images of the rock samples 47. The imaging device 56 may be any type of optical or electronic microscope, camera, etc. The images obtained by the imaging device 56 may be digital images, which can be automatically analyzed as discussed in further detail below. The examples below are given with cameras detecting visible light spectrum, but the same methods may be applied to an image taken with infrared (IR) or ultraviolet (UV) camera detecting light in UV or IR domains. The imaging system 54 may also include a control device 58 (e.g., processor-based controller) to control the imaging device 56 and operational conditions (e.g., lighting, temperature, moisture) associated with the image taking process inside the imaging system 54. For example, the control device 58 may adjust the parameters (e.g., focus, exposure, shutter speed, brightness and color, contrast, filter, resolution, zooming) of the imaging device 56. The preparation device 52 and/or the imaging system 54 may be located at the oil and gas work site 10, or at one or more remote locations.

An analysis system 60 may be used to receive and analyze image data (e.g., digital images) from the imaging system 54 directly or via a network 61. The analysis system 60 may be located at the oil and gas work site 10, or at one or more remote locations. The analysis system 60 may include a communication component 62, a processor 64, a memory 66, a data storage 68, input/output (I/O) ports 70, a display 72, a predictive engine 74, and the like. The network 61 may include transceivers, receivers, and/or transmitters to facilitate data communication to and/or from the analysis system 60. For example, image data from the imaging system 54 may be transmitted to the analysis system 60 through the network 61. Further, external data (e.g., data about a geologic formation) may be gathered from a remote system and transmitted to the analysis system 60 via the network 61. However, in some embodiments, data may be transmitted directly from the devices (e.g., the imaging system 54) to the analysis system 60. Indeed, the analysis system 60 may communicate with the devices directly and/or through the network 61 in accordance with present embodiments. In certain embodiments, the data (e.g., image data) may be automatically communicated from the imaging system 54 to the analysis system 60 for analysis in real-time, thereby enabling real-time responses (e.g., adjusting imaging system 54, retaking images that are unacceptable, adjusting drilling system 12, etc.) to information obtained from analysis of the data.

The communication component 62 may be a wireless or wired communication component (e.g., circuitry) that may facilitate communication between the analysis system 60, various types of devices, the network 61, and the like. Additionally, the communication component 62 may facilitate data transfer to the analysis system 60, such that the analysis system 60 may receive data from the other components depicted in FIG. 1 and the like. The communication component 62 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

The processor 64 may include single-threaded processor(s), multi-threaded processor(s), or both. The processor 64 may process instructions stored in the memory 66. The processor 64 may also include hardware-based processor(s) each including one or more cores. The processor 64 may include general purpose processor(s), special purpose processor(s), or both. The processor 64 may be communicatively coupled to other internal components (such as the communication component 62, the data storage 68, the I/O ports 70, and the display 72).

The memory 66 and the data storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. As used herein, applications may include any suitable computer software or program that may be installed onto the analysis system 60 and executed by the processor 64. The memory 66 and the data storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. The display 72 may operate as a human machine interface (HMI) to depict visualizations associated with software or executable code being processed by the processor 64. The display 72 may display a map of the geological formation data (e.g., images and information derived from the images) corresponding to positions on the map, alerts/alarms when image data is not acceptable, recommendations associated with the alerts/alarms, etc. In one embodiment, the display 72 may be a touch display capable of receiving inputs from an operator of the analysis system 60. The display 72 may be any suitable type of display, such as a liquid crystal display (LCD), plasma display, or an organic light emitting diode (OLED) display, for example. Additionally, in one embodiment, the display 72 may be provided in conjunction with a touch-sensitive mechanism (e.g., a touch screen) that may function as part of a control interface for the analysis system 60.

It should be noted that the components described above with regard to the analysis system 60 are exemplary components and the analysis system 60 may include additional or fewer components as shown. In addition, although the components are described as being part of the analysis system 60, the components may also be part of any suitable computing device described herein such as the sieve 46, the conveyor 50, the preparation device 52, the imaging device 56, the control device 58, and the analysis system 60, and the like to perform the various operations described herein.

In some embodiments, the predictive engine 74 may use various machine learning algorithms to analyze images obtained for the rock samples 47 to identify lithology of the rock samples. The predictive engine 74 may utilize one or more predictive models for analysis of the variety of data received by the analysis system 60. Various types of predictive models may be used to analyze data from variety of resources and generate predictive outputs. For example, the predictive engine 74 may be trained with supervised machine learning technique, i.e., a predictive model is trained with training data that includes input data and desired predictive output (e.g., labeled dataset). The predictive engine 74 may also be trained with unsupervised machine learning technique, i.e., a predictive model is trained with training data that includes input data but without desired predictive output (e.g., unlabeled dataset). The predictive engine 74 may include various types of artificial neural networks (ANN), such as Convolution Neural Networks (CNN), Recurrent Neural Networks (RNN), etc. The analysis system 60 may also communicate with a database 76, which may store information associated with the oil and gas work site 10, the drilling system 12, related external resources (e.g., geologic formation history), etc.

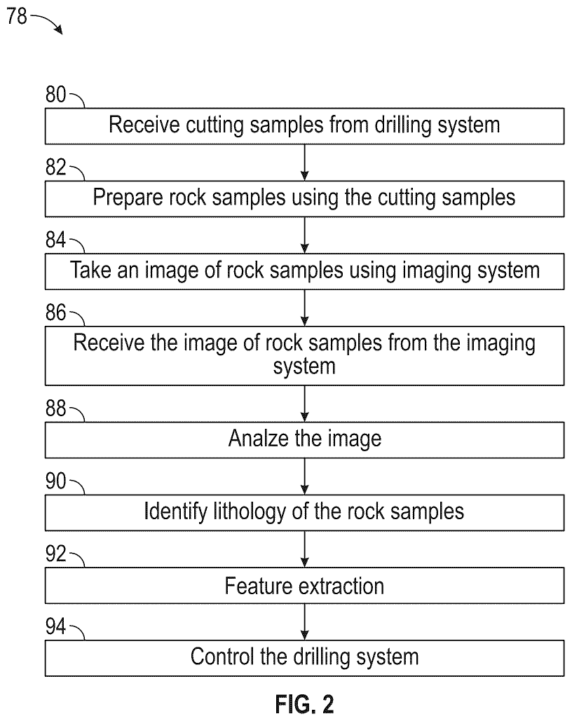

In other embodiments, the predictive engine 74 may be a Large Foundation Model (LFM) is utilized in the recognition of rock particles, such as rock samples 47. Such a LFM can generally be considered to be an Artificial Intelligence (AI) model trained on images. In some embodiments, this training of the LFM does not require images of rock particles for training; alternative images can be used to train the LFM and once trained, the LFM can be utilized to receive an image of rock particles as an input and to generate classification of the image at a pixel level (i.e., each pixel of the image is classified). This allows for identification of, for example, an object and/or a shape of an object, thus providing segmentation of the input image (i.e., of the rock particles image input to the LFM). In this manner, the LFM can operate without any rock particle specific training (e.g., zero shot learning). However, in some embodiments, retraining of the LFM can be undertaken using, for example, specific images of known rock particles. Use of a predictive engine 74 incorporating a LFM is described below in conjunction with FIG. 2.

FIG. 2 is a flowchart of a computer-implemented method 78 for generating a detailed record (e.g., a master log) for the system of FIG. 1. For example, the method 78 may be implemented using one or more processor-based systems (e.g., processor-based controllers) configured to control the drilling system 12, the imaging system 54, the analysis system 60, and/or associated equipment of the oil and gas worksite 10. At block 80, cutting samples at a depth of the wellbore 20 may be received from the drilling system 12. At block 82, as described above, the shale shaker 45 may separate the solid cutting samples from the drilling mud via the sieve 46 to obtain the rock samples 47 (i.e., rock particles). The rock samples 47 may be delivered (e.g., via the conveyor 50) to the preparation device 52, which may prepare the rock samples 47 before sending them to the imaging system 54. The preparation may include washing, rinsing, drying, or sieving the sample of rocks, etc. At block 84, the imaging system 54 may take an optical image of the rock samples 47 by using the control device 58 to control the imaging device 56. At block 86, the analysis system 60 may receive the image of the rock samples from the imaging system 54 for analysis by, for example, the predictive engine 74 as implemented using an LFM. At block 88, the analysis system 60 may analyze the images of the rock samples. This analysis may include, for example, segmentation of the image via the predictive engine 74 utilizing a LFM to classify individual rock particles from the rock samples 47 in the received image to allow for subsequent use in the method 78.

At block 90, the analysis system 60 may use the analyzed image (e.g., the segmented image and/or individual rock particles selected therefrom) to identify lithology of the rock samples. In some embodiments, a user may also interpret the analyzed image and classify the rock particles into different lithology as part of block 90.

After segmentation in block 88 and identification of the lithology of the rock samples 47 (i.e., rock prediction) in block 90, feature extraction in block 92 may be performed. Feature extraction in block 92 can include characterization (i.e., transformation) of the segmented image info into a set of parameters (e.g., values) representing color and texture information of each rock particle. Using the features (e.g., vectors), modeling, classification, clustering, etc. can be performed and the results can be utilized to control the drilling system 12 in block 94.

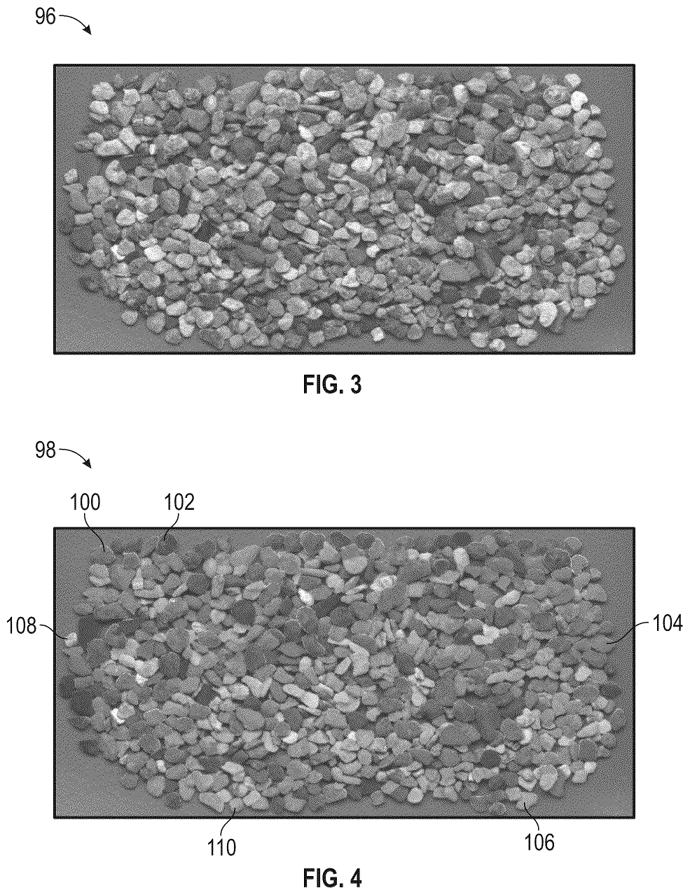

FIG. 3 is an example of an image 96 to be analyzed by the analysis system 60 and, more particularly, the predictive engine 74 utilizing an LFM. The image 96 may be generated and transmitted to the analysis system as part of block 86. Thereafter, in conjunction with block 88, the predictive engine 74, utilizing an LFM, may perform segmentation on image 96. The result of this segmentation is illustrated in FIG. 4.

FIG. 4 illustrates image 98 as an example of image 96 from FIG. 3 having undergone segmentation via the predictive engine 74 utilizing an LFM. As illustrated, image 98 includes rock particles that have been successfully segmented into segmented rock particles as well as rock particles that have not been successfully segmented. For example, cutting 100, cutting 102, cutting 104, and cutting 106 are examples of rock particles in image 98 that have been successfully segmented. Similarly, cutting 108 and cutting 110 are examples of rock particles in image 98 that have not been successfully segmented. That is, cutting 108 and cutting 110 are identical to their corresponding rock particles in image 96.

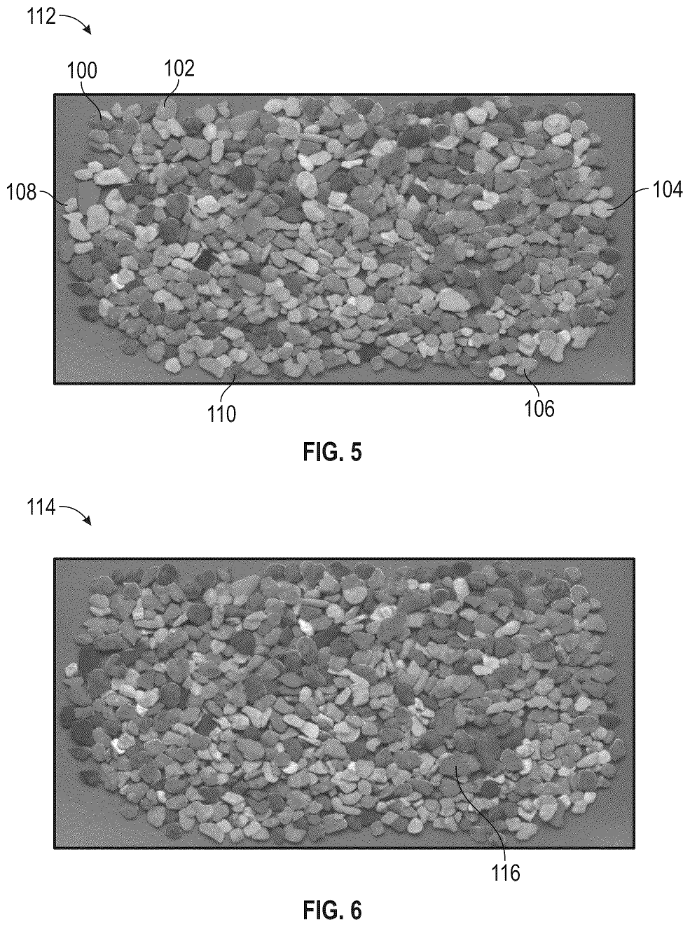

One option to increase the precision of segmented images generated by the predictive engine 74 utilizing an LFM would be to adjust the refinement level that is applied by the predictive engine 74. For example, the image 98 in FIG. 4 may be generated with a default grid setting. This may be a default grid setting of, for example, 32×32 which may generally correspond to a coarse grid. The grid utilized may correspond to, for example, the number of initial points that are defined in the image (e.g., an area to inspect for cutting characterization by the predictive engine 74). Additionally, in some embodiments, an alternative grid setting with higher resolution, for example, 128×128 corresponding to a finer grid may be selected or can be set as the default grid setting. Use of a finer grid, whether selected or set as a default can produce segmented images with increased results (e.g., fewer rock particles in image 98 that have not been successfully segmented. An example of the use of a finer grid by the predictive engine 74 utilizing an LFM is illustrated in FIG. 5.

FIG. 5 illustrates image 112 as an example of image 96 from FIG. 3 having undergone segmentation via the predictive engine 74 utilizing an LFM with a finer resolution than that applied by the predictive engine 74 utilizing an LFM when generating image 98 in FIG. 4. As illustrated, image 112 includes cutting 100, cutting 102, cutting 104, and cutting 106 that that have been successfully segmented into segmented rock particles. Additionally, cutting 108 and cutting 110 are also illustrated as having been successfully segmented into segmented rock particles. In this manner, the image 112 illustrates the increased precision that can be gained when a finer grid resolution is applied via the predictive engine 74. However, it should be noted that use of a finer grid resolution can also increase the amount of time required to generate image 112 of FIG. 5 relative to the amount of time required to generate image 98 of FIG. 4.

In one embodiment, the predictive engine 74 utilizing an LFM can run a first segmentation at a first grid resolution (e.g., coarse). Thereafter, a user (or the analysis system 60) can select a second (finer) grid resolution and re-run the segmentation on the image generated in the first segmentation. The level of grid resolution can be selected by the user, can be a default level, or can be selected by the analysis system 60, for example, based on a percentage or threshold value of rock particles that were not characterized by the first segmentation. In other embodiments, selection of a default and/or second grid resolution can be based on a computation, for example, a separate estimation of a grid size to employ based on, for example, the number of elements in the image to be segmented or another factor. In a further embodiment, a preliminary model (e.g., utilizing a course grid resolution) can be applied as a first segmentation and a second segmentation using a finer resolution grid can be applied over a particular area of the segmented image (i.e., a user or the analysis system 60 select a particular portion of the segmented image where the first segmentation was successful and re-run the segmentation over the remaining area that had less characterizations). In this manner, because the area to be re-segmented is smaller than the original image, the processing time for the second segmentation can be accelerated.

Setting parameters for the model employed via the predictive engine 74 utilizing an LFM can allow for variation (i.e., diversity) in both results and the time utilized to generate those results. One example of parameters that can be set include how many initial points are defined in the image (i.e., the defined region of rock particles). Furthermore, if there is an initial estimate of the size of rock that corresponds to the rock particles, this can be applied to define grid of initial points. Additionally, in some embodiments, if a fully automated model (e.g., foundation model) utilizes more time to process than desired, a light specialized model (based on, for example, Mask R-CNN, as described in U.S. Patent Publication Number 2023/0220761, which was filed Jan. 7, 2022 and which is incorporated by reference herein in its entirety) can be implemented and customized for this task. The light model can be trained after the operations using the high-quality labels (semi-) automatically generated from the foundation model (with fine grid). Thereafter, the foundation model (with a fine grid resolution) can be used after operations are complete and time is less essential. Results generated from this foundational model can provide high quality labels (e.g., inputs) for the retraining of the specialized model. In other embodiments, the foundation model (with a fine grid resolution) can be employed in operations, however, it can be employed on only on the part of images where the specialized model has high uncertainty (e.g., either as a first segmentation or as a selected second segmentation of an area with less characterizations when a coarse grid resolution is implemented as a first segmentation).

In some embodiments, it may be advantageous to allow a user to interact with the images received from block 86 and/or segmented images, for example, segmented images generated as described above using the predictive engine utilizing an LFM. FIG. 6 illustrates image 114 as an example of an image that has undergone segmentation via the predictive engine 74 utilizing an LFM in at least one manner described above. In some embodiments, it may be beneficial for a user to be able to interface with the image 114. Additionally, it should be noted that the techniques and systems described herein with respect to FIGS. 6-10 may alternatively be undertaken on an image to be analyzed by the analysis system 60 and, more particularly, the predictive engine 74 utilizing an LFM (e.g., an image that has yet to undergo segmentation, such as image 96 of FIG. 3).

The image 114 in FIG. 6 includes a cutting 116. As illustrated, cutting 116 has been successfully segmented. As previously noted, the analysis system 60 can include I/O ports 70 that can be coupled to other peripheral components such as input devices (e.g., keyboard, mouse), sensors, input/output (I/O) modules, and the like. Additionally, the display 72 may operate as a human machine interface (HMI) to depict visualizations associated with software or executable code being processed by the processor 64. In one embodiment, the display 72 may be a touch display capable of receiving inputs from an operator of the analysis system 60. In this manner, the display 72 may be provided in conjunction with a touch-sensitive mechanism (e.g., a touch screen) that may function as part of a control interface for the analysis system 60.

Thus, the analysis system 60 can allow for user interaction, for example, to start, control, or operate a graphical user interface (GUI) or applications running on the analysis system 60 and/or to start, control, or operate, for example, portions of the platform executed on the analysis system 60. As may be appreciated, the above referenced GUI may be a type of user interface that allows a user to interact with the analysis system 60 in conjunction with the present platform through, for example, graphical icons, visual indicators, and the like. Thus, the GUI can represents code or a program executed by the analysis system 60, e.g., by the processor 64 interacting with one or more tangible, non-transitory machine-readable medium (e.g., machine readable media, such as the memory 66) of the analysis system 60 that collectively stores instructions, programs, and the like executable by the analysis system 60 to perform the methods and actions described herein, including providing the GUI and receiving and processing user inputs and/or other data inputs.

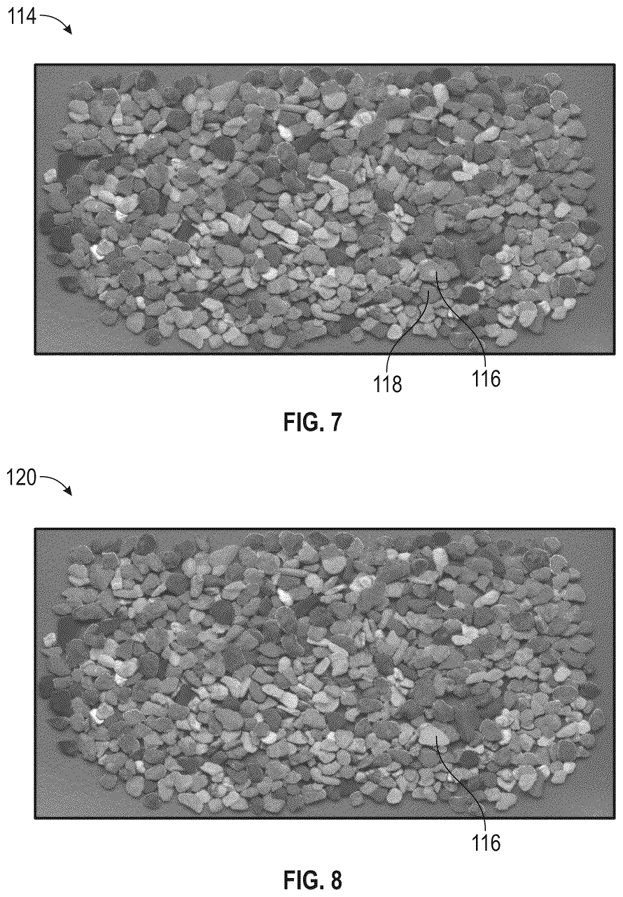

In some embodiments, the GUI allows for interaction with the image displayed for a user, for example, image 114 of FIG. 6. Thus, when a user makes a defined input (e.g., a click of a particular mouse button, a particular interaction with the display, depressing one or more keys on a keyboard, etc.) the GUI can respond with a programmed response. Responses by the GUI can be each programmed to a particular input by a user and in some embodiments, the programming can be altered, for example, by a user (i.e., allowing for user customization of the GUI). FIG. 7 illustrates an example of a particular input and the resulting GUI response.

FIG. 7 illustrates image 114. However, image 114 of FIG. 7 differs in that cutting 116 has been removed from the segmented area due to a particular user input. For example, by entering a left click on the mouse over a particular area of interest in image 114, a segmented area (i.e., cutting 116) is removed. Additionally, the GUI may add a positive point 118 to the area selected by the user. In some embodiments, this positive point 118 may have a corresponding visual representation (e.g., a particular shape and/or color, such as yellow). The positive point 118 can represent, for example, a particular cutting (e.g., 116) to be segmented. An additional (second) user input (e.g., depressing the “Enter” key on a keyboard) can cause segmentation utilizing the particular cutting (e.g., cutting 116).

FIG. 8 illustrates image 120. Image 120 represents an image that includes segmentation utilizing a particular cutting (e.g., cutting 116) subsequent to the second user input (e.g., depressing the “Enter” key on a keyboard). Other user inputs corresponding to actions to be undertaken by the predictive engine 74 utilizing an LFM can be accomplished via the GUI. For example, in some embodiments, in place of a positive point, a negative point may instead be introduced. A negative point can correspond to a region outside of a particular cutting. In some embodiments, the negative point can be used if the positive points are determined to be insufficient and there are additional rock particles to be merged. Additionally, negative points can be automatically added using cutting neighbors (the already segmented rocks could be used as negative guidance).

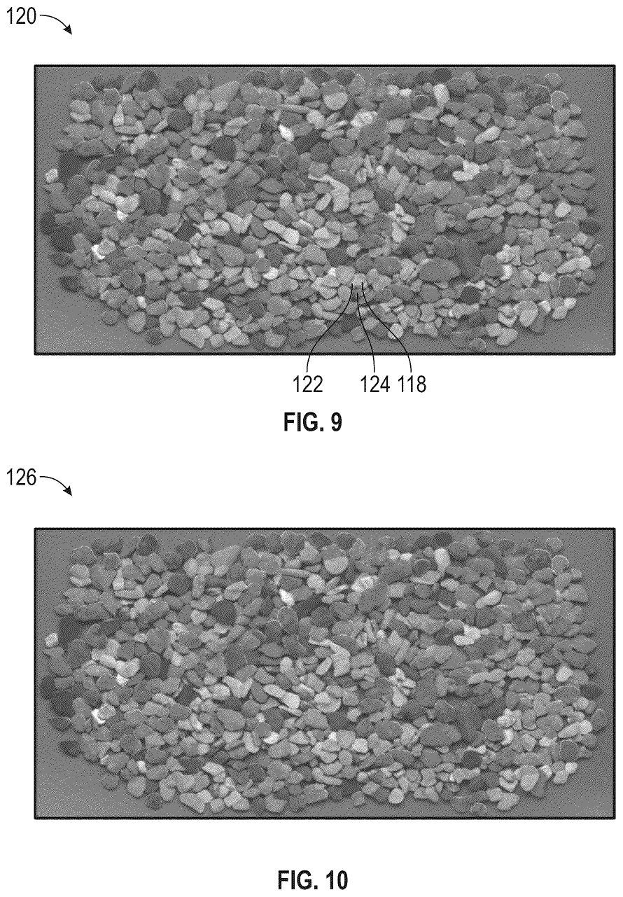

FIG. 9 illustrates an image 120 with the positive point 118 added to an area selected by the user in conjunction with a defined user input (e.g., by entering a left click on the mouse over a particular area of interest in image 120), a segmented area (i.e., cutting 122) is removed (if the area has been segmented). Additionally, the GUI may add a positive point 118 to the area selected by the user. An additional defined input by a user (e.g., entering a right click on the mouse over a particular area of interest in image 120) will result in a negative point 124 being presented to the user. In some embodiments, this negative point 124 may have a corresponding visual representation (e.g., a particular shape and/or color, such as red). An additional user input (e.g., depressing the “Enter” key on a keyboard) can cause segmentation utilizing the particular cutting (e.g., cutting 122) and the negative point 124, resulting in image 126 of FIG. 10. The described annotating of images can be useful in interpretation (e.g., by an operator at wellsite) of images and to classify different rock particles into different lithology, for example, in conjunction with block 90 of method 78. Additionally, in some embodiments, the annotations can be used to improve segmentation model applied by the predictive engine 74 utilizing an LFM.

It is envisioned that other annotations may be made by a user in conjunction with the images to be processed via the predictive engine 74 utilizing an LFM. For example, all points on an image generated by the GUI could be removed in response to a user input, for example, depressing the “Backspace” key. Annotation and subsequent segmentation adjustment can proceed until such time as a user is satisfied with the results of the operations. This can allow for user interaction to optimally detect rock particles. Additionally, the GUI as described herein allows for interaction modify (e.g., correct) segmentation with minimum user interaction (i.e., a reduced number of mouse clicks, keyboard entries, etc.) This allows for a resultant computer system (i.e., the analysis system 60) that through the use of the described visual overlay techniques implemented via the GUI, to provide increases in the efficiency with which users can navigate through various views and windows by providing instantaneous or near instantaneous confirmation of the amount of work performed and/or to be performed. Indeed, by providing the overlays, efficient use of processing power, memory, storage space, network bandwidth, and/or other computing resources is accomplished.

The techniques and system disclosed herein relate to utilizing image analysis via a predictive engine 74 utilizing an LFM. Additional aspects relate to the use of a GUI to allow a user to interact with images of rock particles which then can be segmented using the predictive engine 74 utilizing an LFM. The results may be used as inputs to allow for control of related devices, such as the drilling system 12 and/or drilling plans of the drilling system 12 based on the lithology of the rock samples 47 determined from the segmented images generated by the predictive engine 74 utilizing an LFM. Although the examples described above are illustrated for wellbores on the land, similar method may be applied to any acquisition configuration.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
one or more processors; and
memory, accessible by the one or more processors, and storing instructions that, when executed by the one or more processors, cause the one or more processors to perform operations comprising:
receiving image data of an image of rock samples from an imaging system;
analyzing the image data via an Artificial Intelligence (AI) model trained using a plurality of images; and
generating a segmented image based on the analyzing of the image data via the AI model, wherein the segmented image comprises characterizations of the rock samples of the image data.

2. The system of claim 1, wherein analyzing the image data further comprises applying a first level of resolution to the image data when generating the segmented image.

3. The system of claim 2, wherein the first level of resolution corresponds to a default resolution setting.

4. The system of claim 2, wherein the first level of resolution corresponds to a user selected resolution setting.

5. The system of claim 2, wherein analyzing the image data further comprises applying a second level of resolution to the image data in place of the first level of resolution when generating the segmented image.

6. The system of claim 2, further comprising:
receiving a user input corresponding to a first area of the segmented image; and
generating an adjusted segmented image by removing the rock samples associated with the first area of segmented image from the segmented image.

7. The system of claim 6, further comprising:
analyzing the adjusted segmented image via the AI model; and
generating a second segmented image based on the analyzing of the adjusted segmented image via the AI model, wherein the second segmented image comprises second characterizations of the rock samples of the image data.

8. The system of claim 7, wherein analyzing the adjusted segmented image further comprises applying a second level of resolution to the adjusted segmented image to generate the second segmented image.

9. The system of claim 2, further comprising:
analyzing the segmented image via the AI model; and
generating a second segmented image based on the analyzing of the segmented image via the AI model, wherein the second segmented image comprises second characterizations of the rock samples of the image data.

10. The system of claim 9, wherein analyzing the segmented image further comprises applying a second level of resolution to the segmented image to generate the second segmented image.

11. A computer-implemented method, comprising:
receiving image data of an image of rock samples from an imaging system;
analyzing the image data via an Artificial Intelligence (AI) model trained using a plurality of images; and
generating a segmented image based on the analyzing of the image data via the AI model, wherein the segmented image comprises characterizations of the rock samples of the image data.

12. The computer-implemented method of claim 11, wherein analyzing the image data further comprises applying a first level of resolution to the image data when generating the segmented image.

13. The computer-implemented method of claim 12, further comprising:
receiving a user input corresponding to a first area of the segmented image; and
generating an adjusted segmented image by removing the rock samples associated with the first area of segmented image from the segmented image.

14. The computer-implemented method of claim 13, further comprising:
analyzing the adjusted segmented image via the AI model; and
generating a second segmented image based on the analyzing of the adjusted segmented image via the AI model, wherein the second segmented image comprises second characterizations of the rock samples of the image data.

15. The computer-implemented method of claim 14, wherein analyzing the adjusted segmented image further comprises applying a second level of resolution to the adjusted segmented image to generate the second segmented image.

16. The computer-implemented method of claim 12, further comprising:
analyzing the segmented image via the AI model; and
generating a second segmented image based on the analyzing of the segmented image via the AI model, wherein the second segmented image comprises second characterizations of the rock samples of the image data.

17. The computer-implemented method of claim 16, wherein analyzing the segmented image further comprises applying a second level of resolution to the segmented image to generate the second segmented image.

18. A device, comprising:
a display;
a processor communicatively coupled to the display; and
a memory communicatively coupled to the processor, the memory storing instructions which, when executed, cause the processor to perform operations comprising:
generating a graphical user interface (GUI);
generating an image of rock samples corresponding to image data received from an imaging system for presentation on the display;
receiving a first input via a first user interaction with the GUI;
generating a visual icon for display on the display at a particular location on the image of rock samples displayed on the display, wherein the particular location is determined based upon the first input;
receiving a second input via a second user interaction with the GUI; and
in response to the second input, analyzing at least a portion of the image data via an Artificial Intelligence (AI) model trained using a plurality of images and generating a segmented image based on the analyzing of the at least a portion of the image data by the AI model, wherein the segmented image comprises characterizations of the at least a portion of the rock samples.

19. The device of claim 18, wherein the at least a portion of the image data analyzed by the AI model corresponds to the particular location on the image of rock samples.

20. The device of claim 18, further comprising:
receiving a second input via a second user interaction with the GUI; and
generating a second visual icon for display on the display at a second particular location on the image of rock samples displayed on the display, wherein the second particular location is determined based upon the second input.
